(19) United States
(12) Patent Application Publication
(10) Pub. No.: US 2026/0296117 A1
(43) Pub. Date: Oct. 1, 2026

(54) Lightweight Track-Based Vehicle with Arcuate Suspension Member

(71) Applicant: Kenneth Francis Laux, Bloomington, IN (US)

(72) Inventor: Kenneth Francis Laux, Bloomington, IN (US)

(21) Appl. No.: 19/574,958

(22) Filed: Mar. 23, 2026

Related U.S. Application Data
(60) Provisional application No. 63/777,370, filed on Mar. 25, 2025.

(51) Int. Cl. B60F 1/04; B62K 17/00

(52) U.S. Cl. CPC B60F 1/04; B62K 17/00

(57) ABSTRACT

In a lightweight vehicle for use in an overhead track-based transportation system, in order to facilitate the deployment and retraction of hardware to suspend the vehicle from an overhead track, the hardware comprises a running member that travels on the track and an arcuate suspension member that is connected to the running member and to the vehicle in order to suspend the vehicle from the track. The arcuate suspension member comprises one stationary arcuate part that is joined to a portion of the vehicle and one non-stationary arcuate part that is joined to the running member; the stationary arcuate part and the non-stationary arcuate part are slidably connected. As a result, by sliding the non-stationary part along the stationary part, the hardware can be deployed to enable travel on an overhead track, and can be retracted to optimize travel on the ground or a road, with comparative ease.

### CROSS-REFERENCE TO RELATED APPLICATIONS

This application claims priority from Provisional Patent Application No. 63/777,370, filed Mar. 25, 2025.

### BACKGROUND OF THE INVENTION

### 1. Field of the Invention

This invention relates to a lightweight track-based vehicle having an arcuate suspension member, to be used in an overhead track-based transportation system. The vehicle is intended for use as a “dual-mode” vehicle that can be used either as a conventional vehicle with two or more wheels on the ground or on a road, or as a track-based vehicle suspended from an overhead track, with no wheels or other members of the vehicle in contact with the ground or with a road.

Here and throughout, “arcuate” means having the shape of a circular arc, and “vehicle” means a bicycle (two-wheeled vehicle), or a tricycle (three-wheeled vehicle), or a similarly lightweight vehicle having a still greater number of wheels which make contact with and travel on the ground or a road or other suitable surface, and includes electric-powered versions thereof. “Track” means a long, substantially horizontal rigid member, suspended in the air at an appropriate height, that can support a rolling, sliding, or gliding member (hereafter called the “running member”) that is constrained by the track in the lateral directions, which are defined as the horizontal directions perpendicular to the track length direction; the running member is designed so as to roll, slide, or glide on the track in the track length direction. The running member is attached to the suspension member, which in turn is attached to the vehicle, and as a result the vehicle, being below the track, can be suspended from the track and can travel along the track.

This invention is a further improvement on the invention by this inventor of U.S. Pat. No. 8,689,699, the entire contents of which are incorporated herein by reference.

### 2. Description of the Related Art

In U.S. Pat. No. 8,689,699 by this inventor, an elevated bicycle-based transportation system is proposed which has as an object the securing of greater safety for a vehicle rider, while not impeding use of the vehicle as an ordinary bicycle, tricycle, or other vehicle, and other additional objects.

However, the elevated bicycle-based transportation system has the drawbacks of using vehicles that are cumbersome, that may obstruct the forward visual field of the rider, that are difficult to mount and dismount with special hardware deployed, and that enable modification of the vehicle to enable riding on a track, or to optimize riding on a ground or road surface, only with considerable difficulty.

The present invention was devised in light of the above problems, and has as an object the provision of a vehicle for use in the system of transportation which is substantially less cumbersome, which in at least one mode of use does not obstruct the forward visual field of the rider, which facilitates bicycle mounting and dismounting by making possible mounting and dismounting with the special hardware retracted, and which enables modification of the vehicle for riding on a track, or to optimize riding on a road, with comparative ease, using only components which are secured on the bicycle when ridden in the normal manner. For a vehicle to be used “in the normal manner” means that the vehicle is used with all wheels (either two, in the case of a bicycle, or three, in the case of a tricycle, or four or more wheels) on the ground or road, and without being suspended from an overhead track.

A further object of the present invention is to enable modification of the vehicle for riding on a track without requiring dismounting by the rider.

A further object of the present invention is to enable modification of the vehicle for riding on a track without requiring stopping of the vehicle by the rider.

A further object of the present invention is to enable convenient modification of the vehicle to optimize use in the normal manner without requiring dismounting by the rider, and preferably without requiring stopping by the rider.

A further object of the present invention is to utilize the kinetic power of the vehicle and/or pedaling power of the rider to enable modification of the vehicle for riding on a track and/or for riding in the normal manner.

A further object of the present invention is to further facilitate vehicle mounting and dismounting by positioning the arcuate support member so as to make possible a “step-through” vehicle design.

### BRIEF SUMMARY OF THE INVENTION

In order to attain the above objects, a lightweight track-based vehicle comprises a suspension member, a lower end of which is connected to a portion of the vehicle and an upper end of which is connected to a running member that rolls, slides, or glides on an overhead track, wherein the suspension member is characterized in that:
the suspension member comprises two or more arcuate parts with identical radii of curvature, exactly one of which is a stationary arcuate part that is fastened to a frame or other sturdy portion of the vehicle;
the two or more arcuate parts are mutually slidably joined;
a non-stationary arcuate part is fastened to the running member;
when the suspension member is configured to optimize travel of the vehicle on the ground or road, overlapping of the arcuate parts is substantially maximized; and,
when the suspension member is configured to enable travel of the vehicle on a track, overlapping of the arcuate parts is minimized in such a manner that the running member is approximately above a rider's head.

The arcuate suspension member is configured so as to suspend the vehicle from a track in an attitude similar to the attitude of the vehicle during normal use, and preferably with the plane of the arcuate member containing the direction of vehicle travel, in order to minimize air resistance. The arc described by the arcuate suspension member may be an arc of a circle the center of which is, relative to the normal direction of travel of the vehicle, either in front of or behind a rider. That is, the suspension member may be configured such that the stationary arcuate part is located either in front of or behind the rider, relative to the normal direction of travel of the vehicle.

The vehicle may also comprise a power transmission member to transmit power to one or more non-stationary arcuate parts in order to cause sliding of one or more of the arcuate parts.

The vehicle may also comprise a vehicle frame modified such that the rearmost wheel or wheels are relatively distant from a seat, so that the arcuate suspension member can be positioned between the rear wheel or wheels and the seat.

### BRIEF DESCRIPTION OF THE SEVERAL VIEWS OF THE DRAWING

FIG. 1 is a schematic diagram of an ordinary bicycle, which is an example of a vehicle of the prior art;

FIG. 2 is a schematic diagram of a lightweight track-based vehicle that is a vehicle in a first aspect of the invention, provided with a suspension member that is arcuate and comprises exactly two arcuate parts, wherein (a) shows a configuration that optimizes travel in the normal manner, that is, on the ground or road, and (b) shows a configuration that enables travel on a track;

FIG. 3 is a schematic diagram of another vehicle in a second aspect of the invention, provided with a suspension member that is arcuate and comprises exactly three arcuate parts, wherein (a) shows a configuration that optimizes travel on the ground or road and (b) shows a configuration that enables travel on a track;

FIG. 4 is a cross-sectional diagram of an overlapping portion of the arcuate parts of the suspension member in one embodiment of the first aspect of the invention;

FIG. 5 is a schematic diagram of another vehicle in a third aspect of the invention, provided with an arcuate suspension member and a power transmission member for transmission of kinetic and/or pedaling power from the bicycle so as to move at least one non-stationary arcuate part of the arcuate suspension member upwards in order to enable travel on a track, wherein (a) shows a configuration that optimizes travel in the normal manner and (b) shows a configuration that enables travel on a track;

FIG. 6 is a schematic diagram of another vehicle in a fourth aspect of the invention, provided with a suspension member that is arcuate and a power transmission member for transmission of kinetic and/or pedaling power from the bicycle so as to move at least one non-stationary arcuate part of the arcuate suspension member upwards in order to enable travel on a track, wherein the bicycle frame has been modified such that the rear wheel is relatively distant from the seat, creating a space for a nearly-vertical arcuate suspension member between the rear wheel and the seat. Once again (a) shows a configuration that optimizes travel in the normal manner and (b) shows a configuration that enables travel on a track; and,

FIG. 7 is a schematic diagram of a modification of the vehicle in the first aspect of the invention, in which the arcuate suspension member is positioned substantially in front of rather than behind the rider, relative to the normal direction of motion of the vehicle.

### EXPLANATION OF SYMBOLS

1 Bicycle
2 Track
3 Bicycle with modified frame
10 Running member
20 Arcuate suspension member
22, 23 Sliding (non-stationary) arcuate part of suspension member
24 Stationary arcuate part of suspension member
30 Member to facilitate sliding
40 Power transmission member

### DETAILED DESCRIPTION OF THE INVENTION

Below, aspects of the invention are explained, referring to the drawings. However, the aspects should be regarded as merely illustrations intended to aid understanding, and in no way limit the scope of the invention.

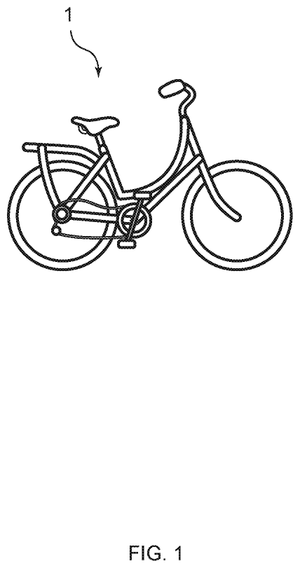

FIG. 1 is a schematic diagram of an ordinary bicycle of the prior art. For clarity, the wheel spokes, brake cables, and other members not relevant to the invention are not shown.

### First Aspect

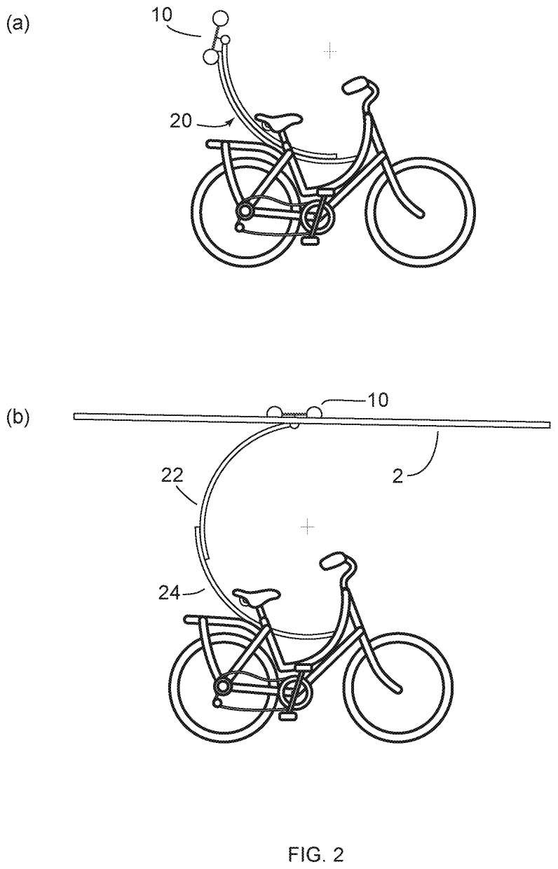

FIG. 2 shows a vehicle provided with a running member 10 comprising a plurality of wheels and an arcuate suspension member 20 in a first aspect of this invention. Also shown is a track 2, comprising, for example, a long steel member with a lengthwise-concave upper surface that can accommodate wheels of the running member. The arcuate suspension member 20 comprises a stationary part 24 and a non-stationary or sliding part 22, both arcuate. Members of the vehicle such as the seat post, in the case of a bicycle, are modified so as to accommodate the arcuate suspension member and/or facilitate fastening of the stationary arcuate part of the suspension member. In the figure, (a) shows the vehicle configured to be used in the normal manner, that is, traveling on the ground or on a road; (b) shows the vehicle configured to be used on a track, that is, with the running member 10 on the track and the wheels of the member able to roll on the track, thereby carrying the vehicle along the track. The running member 10 and the non-stationary part 22 may be deployed to assume the position shown in (b) by the rider by, for example, grasping and pulling upward on a handle or other appendage, not shown, of the non-stationary part 22, until the non-stationary part is locked in the position in (b) by a locking mechanism, not shown. Moreover, the rider may perform the opposite of such actions, unlocking the locking mechanism and, if necessary, lowering the non-stationary part 22, to retract the suspension member so as to optimize the vehicle for travel in the normal manner.

As a result of this aspect, the running member 10 and the non-stationary part 22 can be deployed so as to enable travel on a track without the need for the rider to dismount from the vehicle, and possibly without the need for the rider to stop the vehicle, thereby greatly contributing to rider convenience and ease of use.

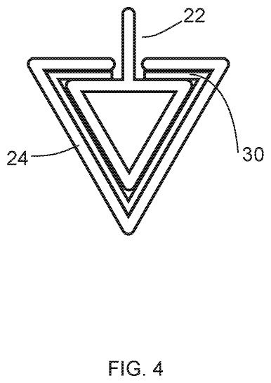

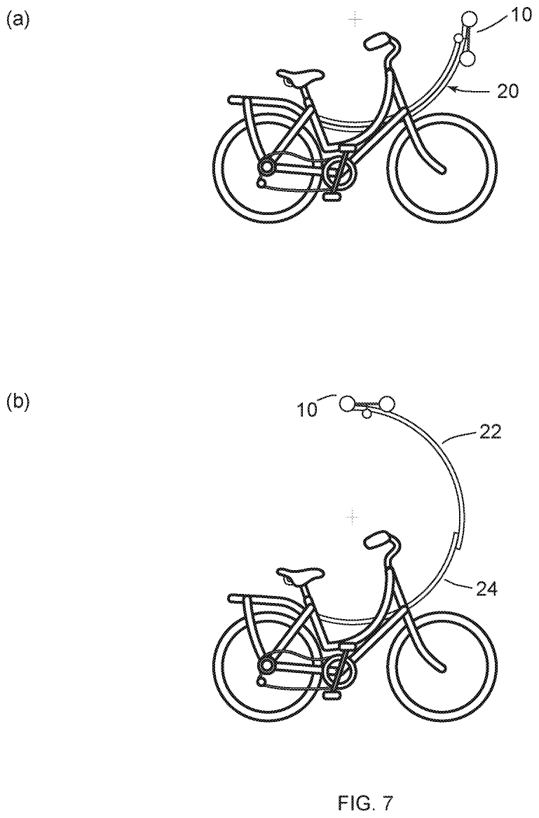

An example of a cross-section of arcuate parts enabling sliding is shown in FIG. 4. FIG. 7 shows a modification of the aspect in which the arcuate suspension member is located substantially in front of rather than behind the rider, relative to the normal direction of motion of the vehicle.

### Second Aspect

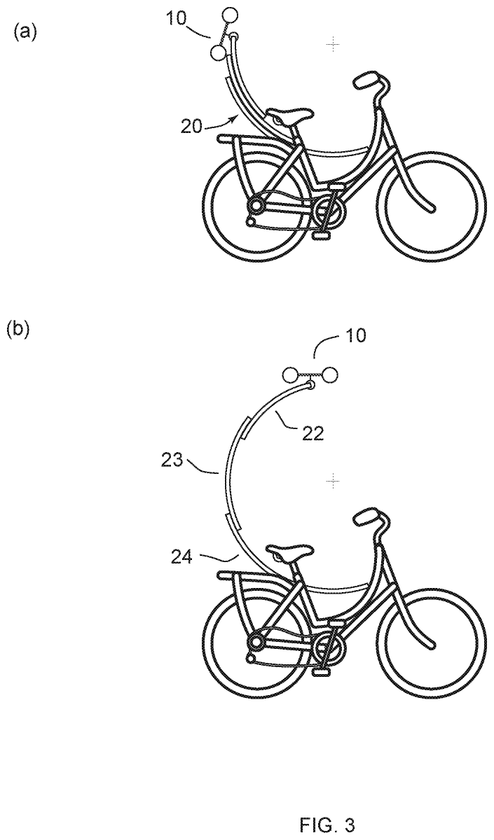

FIG. 3 shows a vehicle provided with a running member 10 and an arcuate suspension member 20 in a second aspect of this invention. The arcuate suspension member 20 comprises a stationary part 24 and two non-stationary or sliding parts 22 and 23. By comprising three parts instead of two, the arcuate suspension member 20 can be shorter when configured for use in the normal manner, and consequently is less of an obstruction and can be more easily manipulated.

### Third Aspect

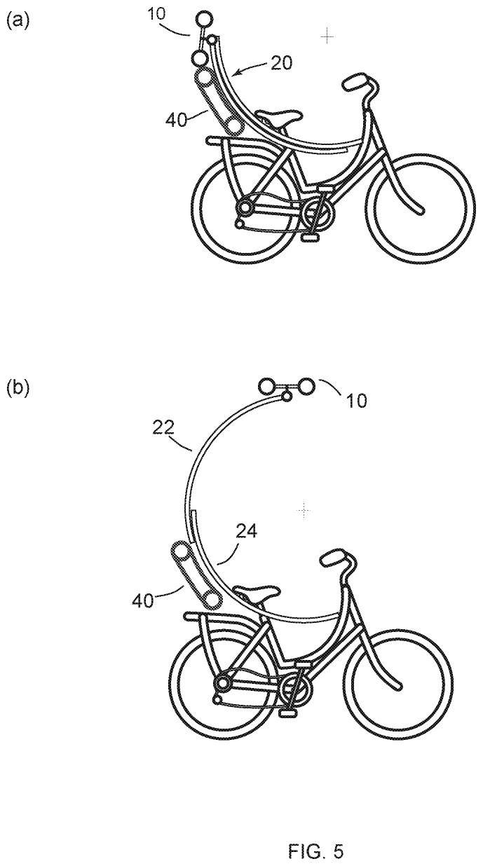

FIG. 5 shows a vehicle provided with a running member 10, an arcuate suspension member 20, and a power transmission member 40, in a third aspect of this invention.

The power transmission member 40 may comprise a gearbox or other device designed for transmission of power from the rear wheel, or from the crankset or other component of the power transmission subsystem of the vehicle, to the non-stationary (sliding) arcuate part so as to move the part upward to achieve a configuration in which the vehicle can travel on a track.

### Fourth Aspect

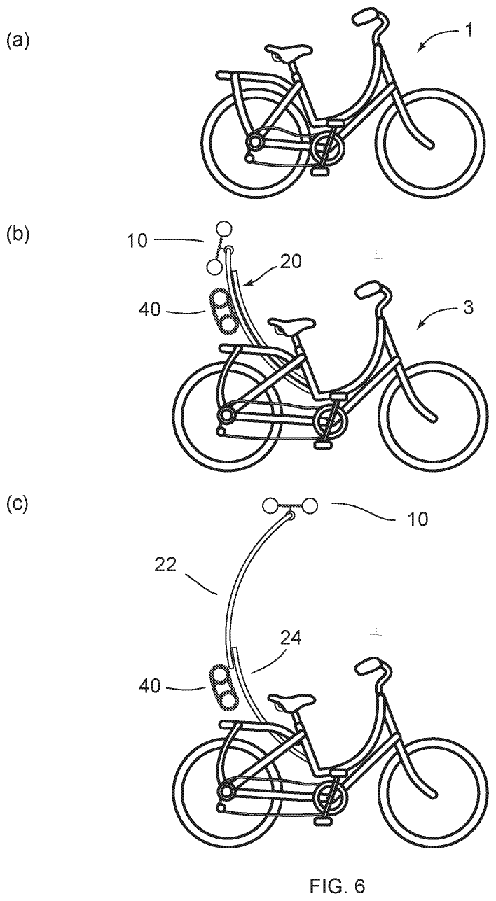

FIG. 6 shows a vehicle 3 provided with a running member 10, an arcuate suspension member 20, and a power transmission member 40, in a fourth aspect of this invention.

The vehicle 3 of the fourth aspect is characterized in that, compared with the vehicle 1, the vehicle frame is modified such that the distance between the rear wheel and the seat is increased, thereby creating a space for the arcuate suspension member 20 between the rear wheel and the seat.

As a result, the running member 10 and the arcuate part 22 can be deployed more easily, either through operation by the rider and/or through operation of the power transmission member 40, and moreover the “step-through” vehicle design is enhanced, so that the rider can more easily mount or dismount the vehicle, without obstruction by the arcuate support member.

It should be understood that various additions, modifications, and improvements can be made to the invention as described herein by a person skilled in the art, and that such additions, modifications, and improvements are to be regarded as encompassed within the scope of the invention.

1. A lightweight track-based vehicle, comprising wheels for travel on the ground or on a road and a running member for travel on an overhead track, and further having an arcuate suspension member for suspending the vehicle from the running member, the arcuate suspension member comprising:
a stationary arcuate part, joined to a portion of the vehicle, and
a non-stationary arcuate part, joined to the running member, and wherein
the stationary and non-stationary arcuate parts have identical radii of curvature and are slidably joined, such that the vehicle can easily be configured by a rider either to optimize travel in the normal manner with the wheels on the ground or road by causing the arcuate parts to substantially overlap, or to enable travel of the vehicle on the overhead track by causing the overlap of the arcuate parts to be substantially minimized such that the running member is substantially above the rider's head and can be placed on and can travel on the overhead track.

2. The lightweight track-based vehicle having an arcuate suspension member according to claim 1, wherein the arcuate suspension member comprises a plurality of non-stationary arcuate parts, the non-stationary arcuate parts being slidably connected in a series, and the first in the series of the plurality of non-stationary arcuate parts being slidably connected to the stationary arcuate part, while the last in the series of the plurality of non-stationary arcuate parts is connected to the running member, such that overlap of the stationary arcuate part with the plurality of non-stationary arcuate parts can be substantially maximized or substantially minimized.

3. The lightweight track-based vehicle having an arcuate suspension member according to claim 1 or claim 2, further comprising a power transmission member that can transmit power from the vehicle to one or more non-stationary arcuate parts in order to cause sliding of the part or parts to substantially increase or substantially decrease overlap of the part or parts with the stationary arcuate part.

4. The lightweight track-based vehicle having an arcuate suspension member according to claim 1 or claim 2, wherein the stationary arcuate suspension part is located substantially behind a rider relative to the normal direction of travel of the vehicle, and the distance between the rear wheel or wheels of the vehicle and a seat of the vehicle is increased in order to accommodate the arcuate suspension member.

5. The lightweight track-based vehicle having an arcuate suspension member according to claim 1 or claim 2, wherein the stationary arcuate suspension part is located in front of a rider relative to the normal direction of travel of the vehicle.
